(19) United States
(12) Patent Application Publication
(10) Pub. No.: US 2026/0122018 A1
(43) Pub. Date: Apr. 30, 2026

(54) METHOD, SERVER, AND USER TERMINAL FOR ACQUIRING AUTHORIZATION OF MEMBER USER IN CHAT ROOM

(71) Applicant: KAKAO CORP., Jeju-si (KR)

(72) Inventor: Ji Hyun SIM, Seongnam-si (KR)

(21) Appl. No.: 19/323,367

(22) Filed: Sep. 9, 2025

(30) Foreign Application Priority Data
Oct. 30, 2024 (KR) 10-2024-0151121

(51) Int. Cl. H04L 51/04; H04L 51/216

(52) U.S. Cl. CPC H04L 51/04; H04L 51/216

(57) ABSTRACT

Proposed is a method for acquiring authorization of a member user in a chat room executed on a user terminal. The method may include displaying a chat room list comprising at least one chat room. The at least one chat room may include a general user and a member user. The method may also include, when a predefined condition related to content displayed in the at least one chat room is satisfied, converting authorization of a user account in a chat room of the at least one chat room from the general user to the member user.

### CROSS-REFERENCE TO RELATED APPLICATION

This application claims priority to and the benefit of Korean Patent Application No. 10-2024-0151121 filed on Oct. 30, 2024, the disclosure of which is incorporated herein by reference in its entirety.

### BACKGROUND

### Technical Field

The present disclosure relates to a method in which a user terminal acquires authorization of a member user in a chat room.

### Description of Related Technology

Recently, it has become common in chat services to grant different authorization to users participating in a chat room. For example, by differentiating the actions that users can perform within a chat room, roles and authorization are set differently for general users and member users. This approach is useful for segmenting the user experience, maintaining order within a chat room, or restricting access to certain features.

### SUMMARY

One aspect is to automatically convert a user account from a general user to a member user when the user account participating in a chat room performs various predetermined interactions.

Another aspect is to distinguish authorization between general users and member users, and to convert a general user to a member user when the general user performs an action permitted only for the member user, thereby increasing user convenience.

Another aspect is a method for acquiring authorization of a member user in a chat room executed on a user terminal, the method including: displaying a chat room list comprising at least one chat room, the at least one chat room comprising a general user and a member user; and when a predefined condition related to content displayed in the at least one chat room is satisfied, converting authorization of a user account in a chat room of the at least one chat room from the general user to the member user.

The method may further include, prior to converting the authorization of the user account to the member user, identifying that the user account is participating in the chat room as the general user.

The method may further include, after converting the authorization of the user account to the member user, displaying, on the chat room list, information regarding current participation of the user account as the member user in the chat room.

The method may further include displaying information on conversion of the authorization of the user account to the member user.

The information regarding conversion of the authorization of the user account to the member user may include at least one of information on whether to consent to conversion to the member user and information indicating that the user account has been converted to the member user.

The method may further include, after converting the authorization of the user account to the member user, displaying the chat room on a member chat room list showing at least one chat room in which the user account is participating as a member use

The user account may initially join the chat room as the member user.

The predefined condition may be related to displaying more content items through a screen change of the chat room.

The chat room may be displayed as either a first screen that displays at least a portion of configuration of the chat room or a portion of content items sent to the chat room, or a second screen that displays the entire configuration of the chat room or the entire content items sent to the chat room. The screen change may include a transition from the first screen to the second screen.

The predefined condition may be related to an interaction by the user with a message displayed within the chat room.

The interaction may include an interaction with a message sent to the chat room.

The interaction with the message may include at least one of a click, a touch, a reply, a comment, and a reaction.

The predefined condition may be related to an interaction with a threaded message in the chat room.

The interaction with the threaded message may include at least one of a request to view the threaded message in the chat room, a request to create a new threaded reply message, and a reaction to the threaded message.

In the chat room, the general user may be allowed to view at most a predetermined number of content items.

The predefined condition may be related to viewing content items exceeding the predetermined number in the chat room.

Thee chat room may include an action permitted only for the member user with respect to the content items, and the predefined condition may be related to the action permitted only for the member user.

Another aspect is a user terminal for acquiring authorization of a member user in a chat room, and the user terminal includes a memory storing instructions, and a processor configured to execute the instructions to: display a chat room list comprising at least one chat room, the at least one chat room comprising a general user and a member user; and when a predefined condition related to content displayed in the at least one chat room is satisfied, convert authorization of a user account in one chat room of the at least one chat room from the general user to the member user.

Another aspect is a method in which a server grants authorization of a member user in a chat room, the method including: providing a chat room list including at least one chat room, the at least one chat room comprising a general user and a member user; and when a predefined condition related to content displayed in the at least one chat rooms is satisfied, providing authorization of the member user to a user account participating in one chat room of the at least one chat room.

Another aspect is a server for providing authorization of a member user in a chat room, and the server includes a memory storing instructions, and a processor configured to execute the instructions to: provide a chat room list including at least one chat room, the at least one chat room comprising a general user and a member user; and when a predefined condition related to content displayed in the at least one chat rooms is satisfied, provide authorization of the member user to a user account participating in one chat room of the at least one chat room.

### BRIEF DESCRIPTION OF THE DRAWINGS

FIG. 1 is a diagram illustrating an example of a network environment according to one embodiment of the present disclosure.

FIG. 2 is a flowchart illustrating a method for acquiring authorization of a member user for a chat room executed on a user terminal of the present disclosure.

FIGS. 3, 4, 5, 6, and 7 are exemplary screens showing that the authorization of a user account is converted from a general user to a member user when a predefined condition related to content displayed in a chat room executed on a user terminal of the present disclosure is satisfied.

FIG. 8 is a flowchart illustrating a method in which a server of the present disclosure grants authorization of a member user to a user account.

### DETAILED DESCRIPTION

Differentiating user statuses based on authorization are essential for effectively utilizing the various functions provided by chat services. Certain features require appropriate authorization, which requires users to have appropriate qualifications within the chat room. While these systems contribute to increasing the efficiency of chat room operations, they may also increase the roles and responsibilities of operators.

If an operator has to manually grant and manage authorization of each user, the operator's workload may increase significantly. Continuous management and supervision of each user is required, and as the number of users increases, the operator's work becomes more complex. In addition, errors in the authorization-granting process or inefficient authorization management may negatively impact the user experience. For example, if authorization are granted excessively or set insufficiently, the smooth operation of order and functions within the chat room may be hindered.

Therefore, in recent years, technological efforts to automatically classify general users and member users in chat services have been increasing to reduce the burden on operators and increase the efficiency of authorization management.

The present disclosure relates to a method in which a user terminal acquires authorization of a member user in a chat room.

Recently, it has become common in chat services to grant different authorizations to users participating in a chat room. For example, by differentiating the actions that users can perform within a chat room, roles and authorizations are set differently for general users and member users.

In this way, differentiating user statuses based on authorizations is essential for effectively utilizing the various functions provided by chat services. Certain features require appropriate authorization, which requires users to have appropriate qualifications within the chat room. While these systems contribute to increasing the efficiency of chat room operations, they may also increase the roles and responsibilities of operators.

If an operator has to manually grant and manage authorizations for each user, the operator's workload may increase significantly. Continuous management and supervision of each user is required, and as the number of users increases, the operator's work becomes more complex. In addition, errors in the authorization-granting process or inefficient authorization management may negatively impact the user experience. For example, if authorizations are granted excessively or insufficiently, the smooth operation and functions of the chat room may be hindered.

Therefore, in recent years, technological efforts to automatically classify general users and member users in chat services have increased to reduce the burden on operators and improve the efficiency of authorization management.

Hereinafter, embodiments disclosed in the present specification will be described in detail with reference to the accompanying drawings. Regardless of the reference numerals, identical or similar components are denoted by the same reference numerals, and redundant descriptions thereof will be omitted. In addition, when describing the embodiments disclosed in the present specification, if a detailed description of related known technology is deemed to obscure the gist of the embodiments, such detailed description will be omitted.

Terms including ordinal numbers, such as first, second, etc., may be used to describe various components, but the components are not limited to the terms. The above terms are used solely to distinguish one component from another.

Singular expressions include plural expressions unless the context clearly indicates otherwise.

In this application, each step described may be performed in an order different from that listed, except where a special causal relationship requires that the steps be performed in the listed order.

In this application, terms such as “include” or “have” are intended to specify the presence of a feature, number, step, operation, component, part, or combination thereof described in the specification, but should be understood not to preclude the possibility of the presence or addition of one or more other features, numbers, steps, operations, components, parts, or combinations thereof.

Hereinafter, the present disclosure will be described with reference to the accompanying drawings.

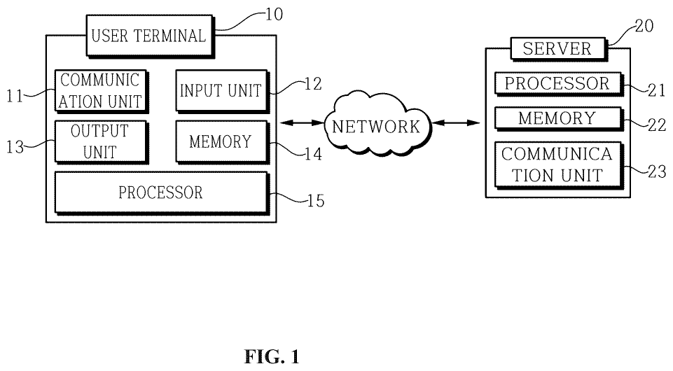

FIG. 1 is a diagram illustrating an example of a network environment according to one embodiment of the present disclosure.

A network environment according to an embodiment of the present disclosure illustrated in FIG. 1 may include a user terminal 10 and a server 20. The user terminal 10 may correspond to at least one user terminal connected to the server 20 via a network.

The communication method of the network is not limited, and the network may include not only communication methods utilizing communication networks (e.g., a mobile communication network, wired Internet, wireless Internet, and broadcasting network), but also short-range wireless communication.

The user terminal 10 may be a terminal that a user uses by logging in with a user account registered in a chat service provided by the server 20.

The user terminal 10 may include a communication unit 11, an input unit 12, an output unit 13, a memory 14, and a processor 15.

The communication unit 11 may communicate with the server 20 or other terminals in a wired or wireless manner.

The input unit 12 may receive various types of information through the user's operation and input actions. The input unit 12 may be a touch screen module, keyboard, mouse, button, camera, stylus, microphone, etc.

The user terminal 10 may receive a user's interaction through the input unit 12. The term “interaction” refers to the input of information reflecting the user's selection or intention into the user terminal 10 by operating the input unit. For example, interactions may include touching a touchscreen, clicking a mouse, typing on a keyboard, sound input from a microphone, capturing an image from a camera, or motion detection by a motion sensor.

The output unit 13 may output various types of information. The output unit 13 may be a display device, a speaker, a vibration generating device, a tactile generating device, and the like. In some cases, the output unit 13 may be a device (e.g., a Bluetooth earphone) that is connected to the user terminal 10 via wired communication or wireless communication (e.g., Bluetooth short-range wireless communication) to receives and outputs a signal.

The memory 14 functions as a storage medium and may store a number of application programs running on the user terminal 10, data for the operation of the user terminal 10, and commands. The memory 14 may be provided in the form of various hardware storage devices such as ROM, RAM, flash drives, and hard drives, or in the form of web storage.

In one embodiment, the memory 14 may store an application related to a chat service that distinguishes between general users and member users.

The processor 15 may control the overall operation of the communication unit 11, the input unit 12, the output unit 13, and the memory 14 to execute an application related to a chat service that distinguishes between general users and member users.

In the present disclosure, the user terminal 10 may display a chat room list including at least one chat room. Here, at least one chat room may have a general user and a member user. When a predefined condition related to content displayed in at least one chat room executed on the user terminal 10 is satisfied, the authorization of the user account in one chat room of the at least one chat rooms may be converted from a general user to a member user.

Here, a general user refers to a user who has not acquired authorization of a chat room. Specifically, the user terminal 10 may participate in one chat room on the chat room list including at least one chat room. If the user terminal 10 has not previously participated in the chat room, the user terminal 10 may join the chat room as a general user. The general user may access limited features within a chat room compared to a member user.

Here, a member user refers to a user who has been granted specific authorization for a chat room. The user account of user terminal 10 may acquire authorization of authorization of a member user upon joining the chat room. In contrast, the user account of the user terminal 10 may join a chat room as a general user, and upon performing a specific interaction in the chat room, the user account may be converted from the general user to a member user.

A member user may perform a wider range of features than a general u For example, a member user may view all messages contained in a chat room. However, a general user may be able to view only a predetermined number of messages (e.g., 10 messages) contained in a chat room. In addition, a member user may enter threaded messages. However, a general user may not be able to enter threaded messages. Here, a threaded message may be a type of message that contains a dependent message for a message sent to a chat room. For example, a threaded message may be a message that contains a dependent message, such as a reply message, a comment message, and the like to an original message sent in the chat room.

Here, the predefined condition related to the content displayed in the chat room refer to the conditions for a general user to acquire authorization of a member user. When the predefined condition related to content displayed in the chat room is satisfied, the server 20 may grant a authorization of a member user to the user account of the user terminal 10.

The server 20 may be implemented as a single computer device or a plurality of computer devices that provide commands, codes, files, content, services, etc. The server 20 may be a server 20 capable of transmitting and receiving information through communication with the user terminal 10 via a network.

The server 20 may include a processor 21, a memory 22, and a communication unit 23.

The processor 21 controls the overall operation of the memory 22 and communication unit 23 to provide the authorization of a member user to the user terminal 10.

The memory 22 functions as a storage medium and may store a number of application programs running on the server 20, data for the operation of the server 20, and commands. In one embodiment, the memory 22 may store an application that provides a chat service comprising general users and member users.

This memory 22 may be provided in the form of various storage devices such as hardware, ROM, RAM, flash drive, hard drive, etc., or may be provided in the form of web storage.

The communication unit 23 may communicate with the user terminal 10 via a network in a wired or wireless manner.

The server 20 of the present disclosure may provide a chat service to the user terminal 10. Specifically, through the chat service, the server 20 may provide a chat room with different authorization of member users and general users to the user terminal 10.

In the present disclosure, the server 20 may provide a chat room list including at least one chat room to the user terminal 10. Here, at least one chat room may have a general user and a member user. When it is determined that a predefined condition related to content displayed in at least one chat room is satisfied, the server 20 may grant the authorization of a member user to a user account participating in at least one chat room.

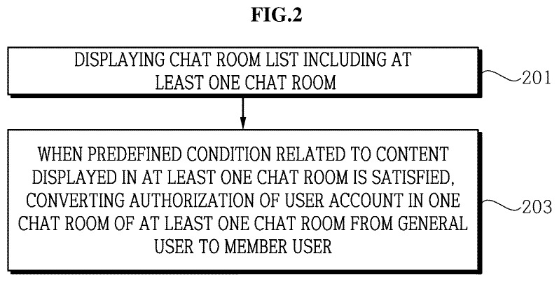

Hereinafter, with reference to FIGS. 2 to 6, a description will be given of one embodiment of a method for converting the authorization of a user account from a general user to a member user in a chat room executed on the user terminal 10 of the present disclosure.

FIG. 2 is a flowchart illustrating a method for acquiring authorization of a member user in a chat room executed on the user terminal 10 of the present disclosure.

In operation 201, the user terminal 10 displays a chat room list including at least one chat room.

The user terminal 10 may display a chat room list including a plurality of chat rooms. The user terminal 10 may participate in one chat room among the chat room list. The user terminal 10 may participate in a chat room upon a request for participation in the chat room.

In some cases, the user terminal 10 may temporarily participate in a chat room. For example, when the user terminal 10 acquires an interaction with a chat room among a chat room list, the user terminal 10 may temporarily display the chat room.

Temporarily displaying a chat room may be done in various ways.

For example, temporarily displaying a chat room may be displaying at least a portion of configuration of the chat room or a portion of content items sent to the chat room. Specifically, when the server 20 receives an interaction for a chat room from the user of the user terminal 10, the server 20 may provide a chat room smaller in size than the actual chat room to the user terminal 10. In such cases, the small-sized chat room may only display at least a portion of the content items sent to the chat room.

In another example, temporarily displaying a chat room may be displaying the chat room as a secondary screen to a main screen. Specifically, if an interaction with a chat room is acquired while the user terminal 10 is displaying another screen, the user terminal 10 may display the other screen as the main screen and the chat room as the secondary screen. In this case, the main screen may be displayed relatively larger than the secondary screen.

Each chat room may have a general user and a member user. In addition, each chat room may provide different authorization depending on the type of user. For example, in a chat room, the general user may be allowed to view at most a predetermined number of content items. In contrast, the member user may be allowed to view the entire content items sent to the chat room.

In addition, the general user may write general messages in chat rooms, but may not be able to write threaded messages. However, the member user may be able to write general messages and threaded messages in chat rooms.

A plurality of chat rooms displayed on the chat room list may be displayed separately for chat rooms participated in as the general user and chat rooms participated in as the member user. For example, for any chat rooms where the user account is participating, the user terminal 10 may display, on the chat room list, information regarding current participation of the user account as a member user.

In operation 203, when a predefined condition related to content displayed in at least one chat room executed on the user terminal 10 is satisfied, the authorization of the user account in one chat room of at least one chat room is converted from a general user to a member user.

Participation of the user account of the user terminal 10 as a member user may imply that the user account initially joins the chat room as the member user, or that the user account joins the chat room as a general user and then converted to the member user.

For example, if the predefined condition related to the content displayed in the chat room is satisfied at a time when the user account of the user terminal 10 joins the chat room, the user terminal 10 may initially join the chat room as a member user.

In contrast, if the predefined condition is not satisfied at a time when the user terminal 10 joins the chat room, the user terminal 10 may join the chat room as a general user. Afterwards, when the predefined condition is satisfied, the user account of the user terminal 10 may be converted from the general user to the member user.

The predefined condition may be determined in various ways.

For example, the predefined condition may be related to displaying more content items through a screen change.

The chat room may be displayed as either a first screen that displays at least a portion of configuration of the chat room or a portion of content items of the chat room, or a second screen that displays the entire configuration of the chat room or the entire content items of the chat room. In this case, the predefined condition may be a transition from the first screen to the second screen.

Specifically, the predefined condition may be a transition from the secondary screen to the main screen. Specifically, when the user terminal 10 obtains an interaction with the chat room while displaying another screen, the user terminal 10 may display the other screen as the main screen and the chat room as the secondary screen. In this case, the main screen may be displayed relatively larger than the secondary screen. Therefore, the secondary screen may only display at least a portion of the configuration of the chat room or a portion of content items of the chat room. Afterwards, when an interaction is acquired for a chat room displayed as a secondary screen, the user terminal 10 may transition the chat room to the main screen. In this case, the main screen may display more chat room content items than the secondary screen. In this way, when the chat room is transitioned to the main screen, the predefined condition may be satisfied. For example, the secondary screen may correspond to a pop-up screen for the main screen.

In another example, the predefined condition may be related to an interaction by a user with a message displayed within the chat room. Specifically, the interaction may include an interaction with a message sent to the chat room. For example, an interaction with a message may include at least one of a click, a touch, a reply, a comment, and a reaction. When a user performs any of the interactions described above, the predefined condition may be satisfied.

In yet another example, the predefined condition may be related to an interaction with a threaded message in the chat room. Specifically, an interaction with a threaded message may include at least one of a request to view the threaded message, a request to create a new threaded reply message, and a reaction to the threaded message. When a user performs any of the interactions described above, the predefined condition may be satisfied.

In yet another example, the predefined condition may be related to viewing content items exceeding a predetermined number in the chat room. Specifically, in a chat room, a general user may be allowed to view at most a predetermined number of content items. In this case, when a general user views more content items, such as by scrolling up within the chat room, the predefined condition may be satisfied.

In yet another example, the predefined condition may be related to an action permitted only for the member user with respect to content items. For example, the action permitted only for the member user with respect to content items may include viewing a predetermined number of content items, creating a content item, sending a content item, and creating a threaded message. In this case, when a general user performs an action permitted only for the member user, the predefined condition may be satisfied.

When the predefined condition is satisfied, the user terminal 10 may display information regarding conversion to a member user. Here, the information regarding conversion to the member user may include information on whether to consent to conversion to the member user and information indicating that the user account has been converted to the member user.

For example, if the predefined condition is satisfied, the server 20 may provide, to the user terminal 10, information on whether to consent to conversion to the member user. When the server 20 receives, from the user terminal 10, information indicating the consent to conversion to the member user, the server may convert the user account of the user terminal 10 to the member user. In this case, the server 20 may provide, to the user terminal 10, a message indicating that the conversion to the member user has been made.

In some cases, displaying information regarding conversion to a member user may be omitted even if the predefined condition is satisfied. In this case, the user terminal 10 may identify, on the chat room list, a chat room in which the user account of the user terminal 10 is participating as a member user and a chat room in which the user account is participating as a general user. Here, the chat room list may include a chat room list that displays all chat rooms and a member chat room list that displays only chat rooms in which the user is participating as a member.

Specifically, for chat rooms in which the user is participating as a member user, the user terminal 10 may display, on the chat room list, information regarding current participation as a member user, along with other information. However, for chat rooms in which the user is participating as a general user, the user terminal 10 may not display, on the chat room list, information related to participation as a general user or information related to participation as a specific member.

The user terminal 10 may display, on a member chat room list, all chat rooms in which the user terminal 10 participates as a member user. In addition, when the user terminal 10 joins the chat room as a member user, the chat room may be displayed on the member chat room list.

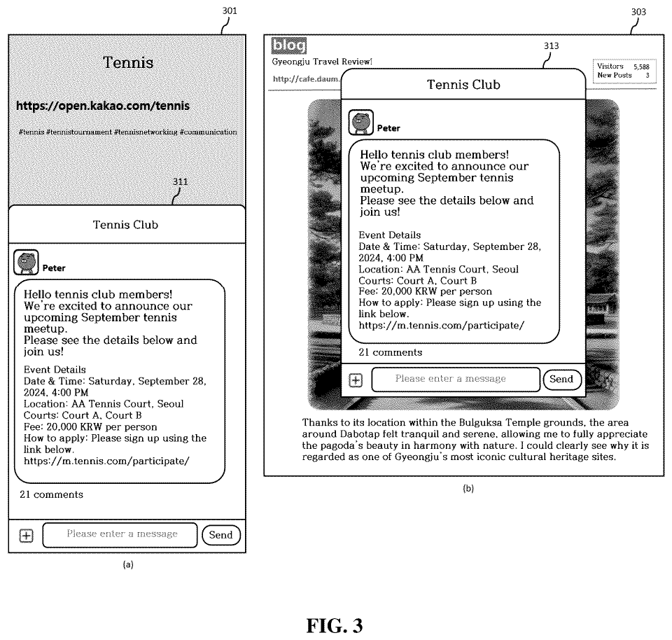

Hereinafter, with reference to FIGS. 3 to 6, an example of a method for converting authorization of a user account executed on the user terminal 10 of the present disclosure from a general user to a member user will be described.

FIG. 3 illustrates a screen in which the user terminal 10 according to one embodiment of the present disclosure displays only at least a portion of the configuration of the chat room or a portion of content of a chat room.

In FIG. 3, (a) illustrates a screen where the user terminal 10 temporarily displays a tennis club chat room 311.

In FIG. 3, (b) illustrates a screen in which the user terminal 10 displays a tennis club chat room 313 as a pop-up screen.

Referring to (a) of FIG. 3, the user terminal 10 may acquire an interaction with a tennis club chat room among a list of chat rooms in a chat service 301. Specifically, the user terminal 10 may acquire, from a user, an interaction with the tennis club chat room 311 among the list of chat rooms. In this case, the user terminal 10 may temporarily display the tennis club chat room 311. Here, the chat room 311 temporarily displayed may show at least a portion of configuration of the chat room 311 or at least a portion of content sent to the chat room 311.

In some cases, as shown in (b) of FIG. 3, when the user terminal 10 acquires an interaction with the tennis club chat room 311, the tennis club chat room 313 may be displayed as a pop-up screen on a main screen 303. In such cases, the pop-up screen may only show at least one message sent to the tennis club chat room 313.

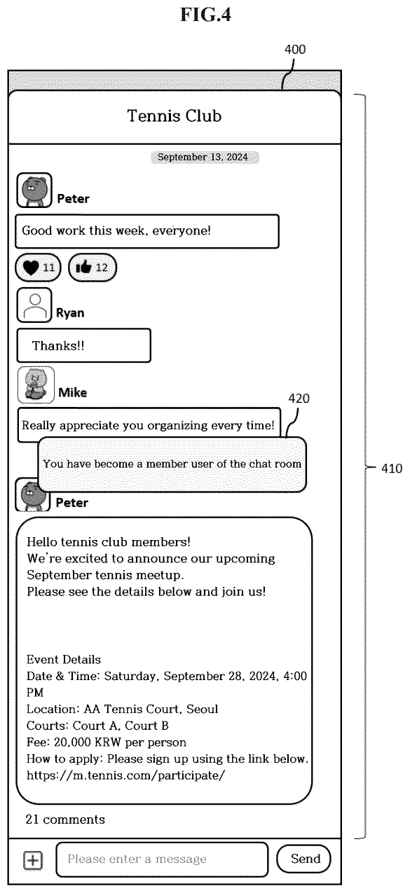

FIG. 4 illustrates a screen in which the user account of the user terminal 10 according to one embodiment of the present disclosure is converted as a member user in a chat room 400.

Referring to FIG. 4, the user terminal 10 may display a second screen 400 that displays all configuration or messages 410 of the chat room. Specifically, when the user terminal 10 acquires an interaction with the tennis club chat room 311 and 313 shown in (a) and (b) of FIG. 3, the user terminal 10 may be converted from a first screen 311 and 313, which displays at least a portion of configuration of the chat room 311 and 313 or a portion of messages sent to the chat room 311 and 313, to a second screen 400, which displays the entire configuration or messages 410 of the chat room 311 and 313, as shown in (a) and (b) of FIG. 3.

If a predefined condition related to content displayed in the chat room is met, the user terminal 10 may participate as a member user in a chat room. Here, the predefined condition may be a transition from the first screen to the second screen 400.

In this case, the user terminal 10 may display information 420 regarding conversion to a member user. For example, the user terminal 10 may display a guidance message 420 such as “You have become a member user of the chat room.”

In addition, although not shown in the drawing, when the predefined condition is satisfied (when the first screen is transitioned to the second screen), the user terminal 10 may display information on whether to consent to conversion to a member user. In this case, once the content to conversion to a member user is identified, the user account of the user terminal 10 may convert to a member user in the tennis club chat room 400.

In some cases, displaying information regarding conversion to a member user may be omitted even if the predefined condition is satisfied. In addition, displaying information on whether to consent to conversion to the member user may be omitted.

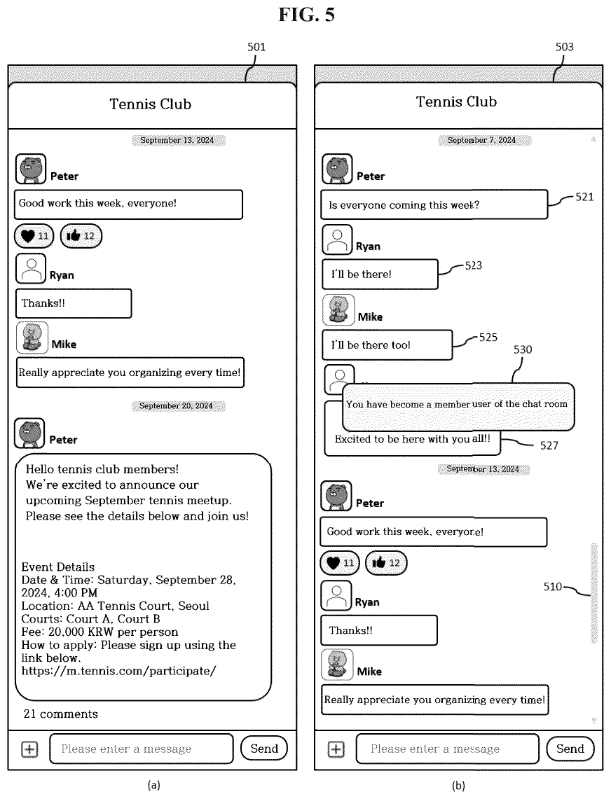

FIG. 5 illustrates a screen in which the user account of the user terminal 10 according to one embodiment of the present disclosure is converted to a member user according to user interaction.

In FIG. 5, (a) illustrates a screen in which the user terminal 10 is participating as a general user in a chat room 501.

In FIG. 5, (b) illustrates a screen in which the user account of the user terminal 10 is converted to a member user of a chat room 503 in response to user interaction.

Referring to (b) of FIG. 5, the user account of the user terminal 10 in (a) of FIG. 5 may display existing content 521, 523, 525, and 527 transmitted to the chat room 503, in response to user interaction of moving a scroll 510. However, general users may be able to view only content recently displayed in a chat window, as in (a) of FIG. 5.

If a predefined condition related to content displayed in the chat room is met, the user terminal 10 may participate as a member user in a chat room. Here, the predefined condition may be that the content 521, 523, 525, 527 exceeding a predetermined number in the chat room 503 is identified. When the predefined condition is satisfied, the user terminal 10 may display information 520 regarding conversion to a member user. For example, the user terminal 10 may display a guidance message 520 such as “You have become a member user of the chat room.”

In some cases, displaying information regarding conversion to a member user may be omitted even if the predefined condition is satisfied. In addition, displaying information on whether to consent to conversion to the member user may be omitted.

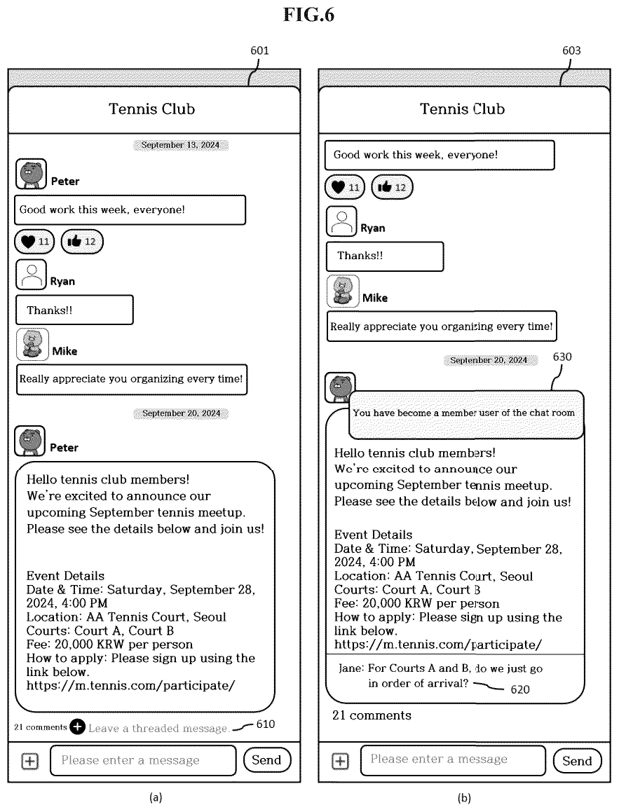

FIG. 6 illustrates a screen in which the user account of the user terminal 10 according to one embodiment of the present disclosure is converted to a member user in response to an interaction with a threaded message.

In FIG. 6, (a) illustrates a screen in which the user account of the user terminal 10 is participating as a general user in a chat room 601.

In FIG. 6, (b) illustrates a screen in which the user account of the user terminal 10 is converted to a member user of a chat room 603 in response to an interaction regarding a threaded message.

Referring to (b) of FIG. 6, the user of the user terminal 10 in (a) of FIG. 6 may input a threaded message for a message sent by Peter in the tennis club chat room 601. Specifically, the user of the user terminal 10 may input a threaded message 620 for the message sent by Peter through an interface 610 for entering a threaded message. However, a general user may be allowed to enter only general chat messages into the chat room, but not threaded messages.

When a predefined condition related to the threaded message is satisfied, the user terminal 10 may participate in the chat room as a member user. Here, the predefined condition related to the threaded message may be entering a reply message to the threaded message. When the predefined condition is satisfied, the user terminal 10 may display information 630 regarding conversion to a member user. For example, the user terminal 10 may display a guidance message 630 such as “You have become a member user of the chat room.”

In some cases, displaying the information regarding conversion to the member user may be omitted even if the predefined condition is satisfied. In addition, displaying the information on whether to consent to conversion to the member user may be omitted.

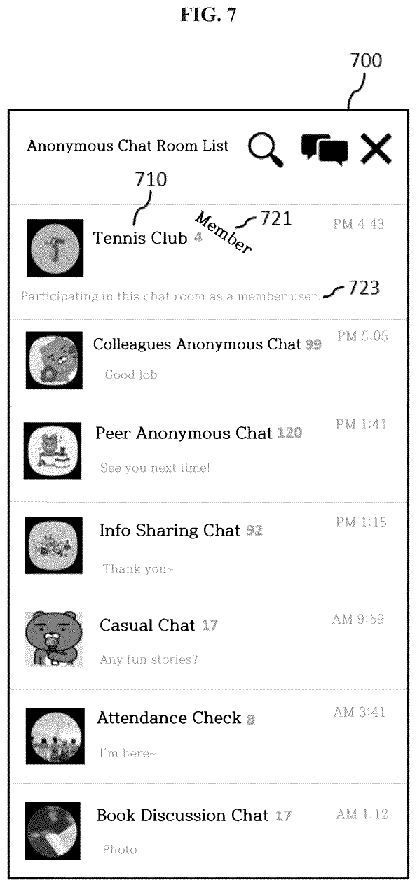

FIG. 7 illustrates a screen in which the user terminal 10 according to one embodiment of the present disclosure displays, via a chat room list 700, a chat room 710 where the user account of the user terminal 10 is participating as a member user.

Referring to FIG. 7, the user terminal 10 may display, on the chat room list 700, information 721 and 723 regarding current participation as a member user. Specifically, when the user account of the user terminal 10 is converted from a general user to a member user, the user terminal 10 may display the information 721 and 723 regarding current participation in the chat room 710 as a member user.

For example, information regarding current participation as a member user may include an indicator such as “Member” 721 and guidance text 723 such as “Participating in this chat room as a member user.”

Although not shown in the drawing, the user terminal 10 may display a member chat room list that displays only chat rooms in which the user of the user terminal 10 is participating as a member user. In this case, the chat room 710 in which the user of the user terminal 10 is participating as a member user may be displayed on a member chat room list.

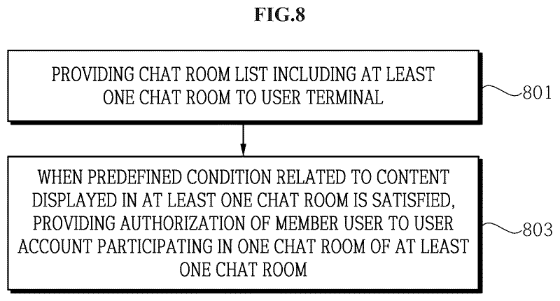

FIG. 8 is a flowchart illustrating a method in which the server 20 of the present disclosure grants the authorization of a member user to a user account.

For convenience of explanation, the description of steps in FIG. 8 that are substantially the same as steps in FIG. 2 will be replaced with a description referring to FIG. 2.

In operation 801, the server 20 provides a chat room list including at least one chat room to the user terminal. Since operation 801 is substantially the same as operation 201 of FIG. 2, the description of operation 801 is replaced with the description of operation 201 of FIG. 2.

In operation 803, when the server 20 confirms that a predefined condition related to the content displayed in at least one chat room is satisfied, the server 20 grants the authorization of a member user to a user account participating in at least one of the chat rooms. Since operation 803 is substantially the same as operation 203 of FIG. 2, the description of operation 803 will be replaced with the description of operation 203 of FIG. 2.

In the present disclosure, when a user participating in a chat room performs various predetermined interactions, it is possible to automatically convert the user from a general user to a member user, thereby increasing user convenience.

In addition, in the present disclosure, it is possible to distinguish authorization of general users and member users, and to convert the authorization of the user account from a general user to a member user when the general user performs an action permitted only for the member user, thereby increasing user convenience.

The technical features disclosed in each embodiment of the present disclosure are not limited to that embodiment, and unless they are mutually incompatible, the technical features disclosed in each embodiment may be combined and applied to other embodiments.

Therefore, although each embodiment focuses on its own technical features, each technical feature may be applied in combination with each other as long as they are not mutually incompatible.

The present disclosure is not limited to the above-described embodiments and the attached drawings, and various modifications and variations are possible from the viewpoint of a person skilled in the art to which the present disclosure pertains. Therefore, the scope of the present disclosure should be defined not only by the claims of this specification but also by equivalents thereto.

What is claimed is:

1. A method for acquiring authorization of a member user in a chat room executed on a user terminal, the method comprising:
displaying a chat room list comprising at least one chat room, the at least one chat room comprising a general user and a member user; and
in response to a predefined condition related to content displayed in the at least one chat room being satisfied, converting authorization of a user account in a chat room of the at least one chat room from the general user to the member user.

2. The method of claim 1, further comprising, prior to converting the authorization of the user account to the member user, identifying that the user account is participating in the chat room as the general user.

3. The method of claim 1, further comprising, after converting the authorization of the user account to the member user, displaying, on the chat room list, information regarding current participation of the user account as the member user in the chat room.

4. The method of claim 1, further comprising: displaying information regarding conversion of the authorization of the user account to the member user.

5. The method of claim 4, wherein the information regarding conversion of the authorization of the user account to the member user comprises at least one of information on whether to consent to conversion to the member user or information indicating that the user account has been converted to the member user

6. The method of claim 1, further comprising, after converting the authorization of the user account to the member user, displaying the chat room on a member chat room list showing at least one chat room in which the user account is participating as a member user.

7. The method of claim 1, wherein the user account initially joins the chat room as the member user.

8. The method of claim 1, wherein the predefined condition is related to displaying more content items through a screen change of the chat room.

9. The method of claim 8, wherein:
the chat room is displayed as either a first screen that displays at least a portion of configuration of the chat room or a portion of content items sent to the chat room, or a second screen that displays the entire configuration of the chat room or the entire content items sent to the chat room, and
the screen change comprises a transition from the first screen to the second screen.

10. The method of claim 1, wherein the predefined condition is related to an interaction by the user with a message displayed within the chat room.

11. The method of claim 10, wherein the interaction comprises an interaction with a message sent to the chat room.

12. The method of claim 11, wherein the interaction with the message comprises at least one of a click, a touch, a reply, a comment, and a reaction.

13. The method of claim 1, wherein the predefined condition is related to an interaction with a threaded message in the chat room.

14. The method of claim 13, wherein the interaction with the threaded message comprises at least one of a request to view the threaded message in the chat room, a request to create a new threaded reply message, and a reaction to the threaded message.

15. The method of claim 1, wherein in the chat room, the general user is allowed to view at most a predetermined number of content items.

16. The method of claim 15, wherein the predefined condition is related to viewing content items exceeding the predetermined number in the chat room.

17. The method of claim 1, wherein:
the chat room comprises an actions permitted only for the member user with respect to the content items, and
the predefined condition is related to the action permitted only for the member user.

18. A user terminal for acquiring authorization of a member user in a chat room, the user terminal comprising:
a memory storing instructions, and
a processor configured to execute the instructions to:
display a chat room list comprising at least one chat room, the at least one chat room comprising a general user and a member user; and
in response to a predefined condition related to content displayed in the at least one chat room being satisfied, convert authorization of a user account in one chat room of the at least one chat room from the general user to the member user.

19. A method in which a server grants authorization of a member user in a chat room, the method comprising:
providing a chat room list including at least one chat room, the at least one chat room comprising a general user and a member user; and
in response to a predefined condition related to content displayed in the at least one chat rooms being satisfied, providing authorization of the member user to a user account participating in one chat room of the at least one chat room.
